(19) United States
(12) Patent Application Publication
(10) Pub. No.: US 2025/0198232 A1
(43) Pub. Date: Jun. 19, 2025

(54) FENESTRATION ASSEMBLIES INCLUDING CONDUCTIVE INTERFACES AND METHODS FOR SAME

(71) Applicant: Marvin Lumber and Cedar Company, LLC d/b/a Marvin Windows and Doors, Eagan, MN (US)

(72) Inventors: Chase Voorhees, Roseau, MN (US); Blake Burger, West Fargo, ND (US)

(21) Appl. No.: 18/988,170

(22) Filed: Dec. 19, 2024

Related U.S. Application Data
(60) Provisional application No. 63/612,155, filed on Dec. 19, 2023.

(51) Int. Cl. E06B 7/28; E06B 3/42; H01R 13/24

(52) U.S. Cl. CPC E06B 7/28; E06B 3/42; H01R 13/2407

(57) ABSTRACT

A fenestration assembly comprising at least a fenestration frame, a fenestration panel where the fenestration panel is configured to move between open and closed positions, and an interface assembly coupled between the fenestration frame and the fenestration panel. In examples, the interface assembly includes at least one or more bridge contacts coupled with one of the fenestration frame or fenestration panel and one or more opposed contacts coupled with the other of the panel or the fenestration frame.

### CLAIM OF PRIORITY

This patent application claims the benefit of U.S. Provisional Patent Application No. 63/612,155, filed Dec. 19, 2023, which is incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Marvin Lumber and Cedar Co. d/b/a Marvin Windows and Doors LLC. All Rights Reserved.

### TECHNICAL FIELD

This document pertains generally, but not by way of limitation, to fenestration assemblies and conductive interfaces between panels and frames.

### BACKGROUND

Fenestration systems, such as windows, doors, skylights, or the like are examples of openings in buildings that allow ingress and egress or views of environments outside of a room or building. Fenestration systems also provide barriers to entry from outside environments. For example, entry or exit from a room is allowed or prohibited through doors and sometimes windows. Environmental elements, such as weather or animals, in other examples are prohibited from entry into a building through fenestration. In other examples, fenestrations prohibit or minimize light or viewing through fenestration.

In certain examples, fenestration systems include electrical components. Examples include electrical components including wireless transmitters that communicate information about the fenestration. Information includes, for example, if the fenestration is open or closed or if the fenestration is shaded, opaque, or clear, or other information useful to a user.

In another example, electrical components include power transmission. In an example, operating the above-described wireless transmissions requires power, whether battery or a hardwired connecting. In examples utilizing power, electrical connections are provided between parts of the fenestration system. For instance, connections are provided between a frame and a door or panel.

### OVERVIEW

The present inventors have recognized, among other things, that a problem to be solved includes, for example, maintaining a conductive relationship with an interface for a fenestration assembly. For example, a conductive interface allows for communication with components of the fenestration assembly or external systems. In another example, the conductive interface allows for power to be supplied to the fenestration assembly or components of the fenestration assembly. The conductive interface discussed herein permits one or more of communication or power to the fenestration assembly while the assembly is open, closed and therebetween (e.g., at intermediate positions or while moving).

In some examples, wireless transmitters provide communication between disconnected components. For example, wireless transmitters provide communication between the fenestration assembly and a control system or an external communication system (e.g., application, alarm system or the like). In some examples, because of the location of the fenestration assembly or the environment the fenestration assembly is in, wireless communication is unreliable.

Some example wireless transmitters receive power from batteries or through wiring to a remote power source, or the like. In the context of fenestration assemblies, batteries have large profiles and occupy relatively large portions of the fenestration assemblies. Batteries, for example, are subject to depletion and are unreliable. Even when batteries are rechargeable, they have a limited operating lifetime. Additionally, wiring requires routing with flexible conduit to permit interconnection between moving components. The flexible conduit also occupies volume in fenestration assemblies that is otherwise available for larger panes, other fenestration components or the like.

In examples, hardwiring solutions include wires or bundles of wires with one end portion coupled with an external power or data source and the other end portion coupled with the fenestration assembly. Hardwired solutions, in some examples, are voluminous or extensive. In other examples, hardwiring is cumbersome and impedes or hampers movement of fenestration assemblies. For instance, repeated movement of a fenestration assembly containing a flexible conduit is at risk of deformation or undesirable bunching or tangling. Undesirable bunching or tangling of the conduit, wiring or both that, in some instances, impedes fenestration panel movement.

In other examples, inductive power systems are included in the fenestration assembly. The inductive power system includes a power source that provides power inductively to a disconnected component. The inductive power system includes coils, a power source and the like to operate. The components for an inductive power system occupies volume (in some cases significant volume) in the fenestration assembly. Additionally, inductive power is, in some examples, unreliable and a supplemental power source (e.g., a battery) is provided with the remote portion to address shortfalls.

In still other examples, depressible pins (also referred to as pogo pins) are used to provide electrical communication. The depressible pins include spring biased pins that are aligned with a metal contact on an opposed surface. As the opposed surface is engaged with the pin, the pin is depressed, and electrical contact is made. Accordingly, the depressible pins are disconnected from their opposed contacts with opening, adjustment or movement of the fenestration panel.

Further, the depressible pins are precisely aligned with the opposed contacts to ensure electrical connection upon depression. In the context of fenestration assemblies, frames or panels (sashes or doors) settle, move, are adjusted or the like, and accordingly maintaining alignment is difficult. In some examples, during installation, adjustment or after operation of the assembly for some time, either or both of the contacts or depressible pins misalign, and electrical contact is lost or is poorly maintained.

In certain examples, data or information about the fenestration assembly is communicated through aligned components such as depressible pins, sensors or the like. Communicated information includes, for example, open or closed status of the fenestration assembly or if the fenestration assembly is shaded, opaque, or clear or other information that is informative to the operation or use of the fenestration assembly.

In an example, the present subject matter provides a solution to this problem with, for instance, an interface assembly that includes at least an electrical contact on a sliding, rotating, or otherwise moving panel and an opposing electrical contact on the frame that are continuously engaged (e.g., including one or more of open, closed, intermediate positions therebetween, while in motion or the like).

In an example, the present subject matter provides a solution to problems related to consistent communication or power distribution to fenestration assemblies having one or more moving panels. For example, consistent communication or power to fenestration assemblies is provided through electrical transmission along or between one or more bridge contacts, such as a first bridge contact in deformable engagement with an opposed second contact. Communication, such as a transmission of data or electricity, between the bridge contact and the opposed contact is maintained by the engagement (mechanical connection) of the bridging contact with the opposed contact in one or more of the open or closed positions, intermediate positions therebetween, or during motion of the fenestration assembly, such as sliding movement of a panel or sash.

The one or more bridge contacts include a deformable element that permits deformation in response to a depressive force. Additionally, the one or more bridge contacts provide a reciprocal bias distributed along the bridge contact (e.g., along a length) toward the opposed contact. In one example, depression and reciprocal bias of the bridge contact toward the opposed contact is distributed laterally, such as between end portions of the bridge contact.

The broad provision of electrical contact provides a distributed interface for the communication of power and data. The deformation and lateral distribution of electrical contact permits communication in various positions (e.g., closed, open, intermediate positions, and moving therebetween). Further, the lateral profile of the bridge contact permits the hand-off of engagement between the bridge contact and the opposed contact of the interface assembly, for instance to supplemental bridge contacts or opposed contacts.

The one or more bridge contacts are engaged along the opposed contact, and the reciprocal bias provided by the at least one bridge contact maintains that engagement. For instance, the engagement is continuous (e.g., provided in one or more of open, closed, intermediate positions, and with motion therebetween). In another example, with an opposed contact that is a deformable bridge contact (e.g., a second bridge contact) both of the deformable bridge contacts cooperatively deform, provide reciprocal bias, and thereby maintain electric contact, such as continuous engagement.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is a perspective view of one example of a fenestration assembly including a door assembly according to at least one example of the present disclosure.

FIG. 1B is a front view of one example of a fenestration assembly including a window assembly according to at least one example of the present disclosure.

FIG. 2 is a detailed perspective view of one example of an interface assembly installed with a fenestration panel according to at least one example of the present disclosure.

FIG. 3 is a perspective cross section of an interface assembly according to at least one example of the present disclosure.

FIG. 4 is a side view of one example of a bridge contact according to at least one example of the present disclosure.

FIG. 5A is a perspective view of one example of a pair of bridge contacts on a fenestration panel according to at least one example of the present disclosure.

FIG. 5B is a perspective view of an example of a pair of opposed bridge contacts on a fenestration frame according to at least one example of the present disclosure.

FIG. 6A is a perspective view of a fenestration assembly including a fenestration panel in a closed position according to at least one example of the present disclosure.

FIG. 6B is another perspective view of the fenestration assembly of FIG. 6A including the fenestration panel in a transition position according to at least one example of the present disclosure.

FIG. 6C is another perspective view of the fenestration assembly of FIG. 6A including a fenestration panel in a transition position according to at least one example of the present disclosure.

FIG. 7A is a schematic view of one example of a bridge contact and an opposing contact in transition as a fenestration panel is moved relative to the remainder of a fenestration assembly according to at least one example of the present disclosure.

FIG. 7B is another schematic view of the bridge contact and an opposing contact of FIG. 7A in transition according to at least one example of the present disclosure.

FIG. 7C is another schematic view of the bridge contact and an opposing contact of FIG. 7A in transition according to at least one example of the present disclosure.

FIG. 7D is a schematic view of another example of a bridge contact and an opposing contact in transition according to at least one example of the present disclosure.

FIG. 8 is a side view of a plurality of bridge contacts and opposed contacts arranged in series according to at least one example of the present disclosure.

FIG. 9A is a schematic view of a fenestration assembly including a deformable bridge contact and more than one opposed bridge contacts according to at least one example of the present disclosure.

FIG. 9B is a schematic view of another fenestration assembly including a deformable bridge contact and more than one opposed bridge contacts according to at least one example of the present disclosure.

FIG. 10 is a side view of a fenestration assembly including a deformable bridge contact and more than one opposed contact according to at least one example of the present disclosure.

FIG. 11A is a perspective view of another example of a fenestration assembly with a carriage according to at least one example of the present disclosure.

FIG. 11B is a front view of another example of a fenestration assembly with a carriage according to at least one example of the present disclosure.

### DETAILED DESCRIPTION

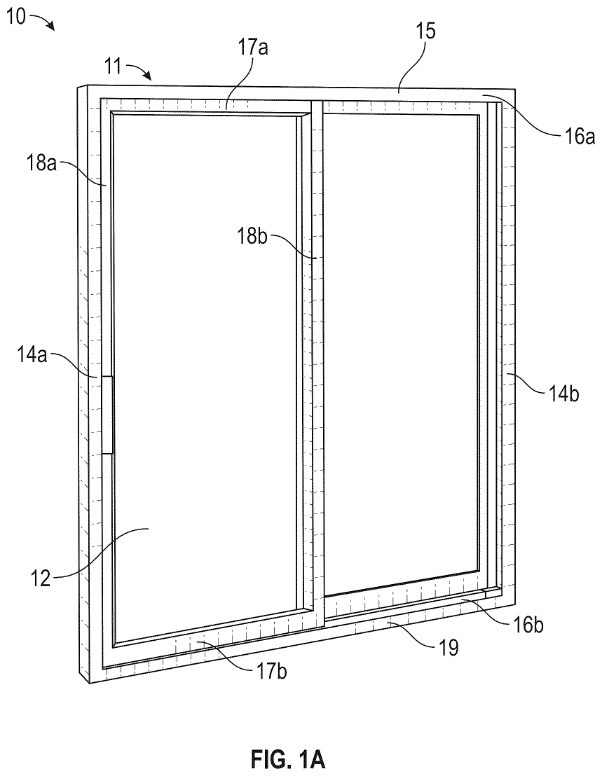

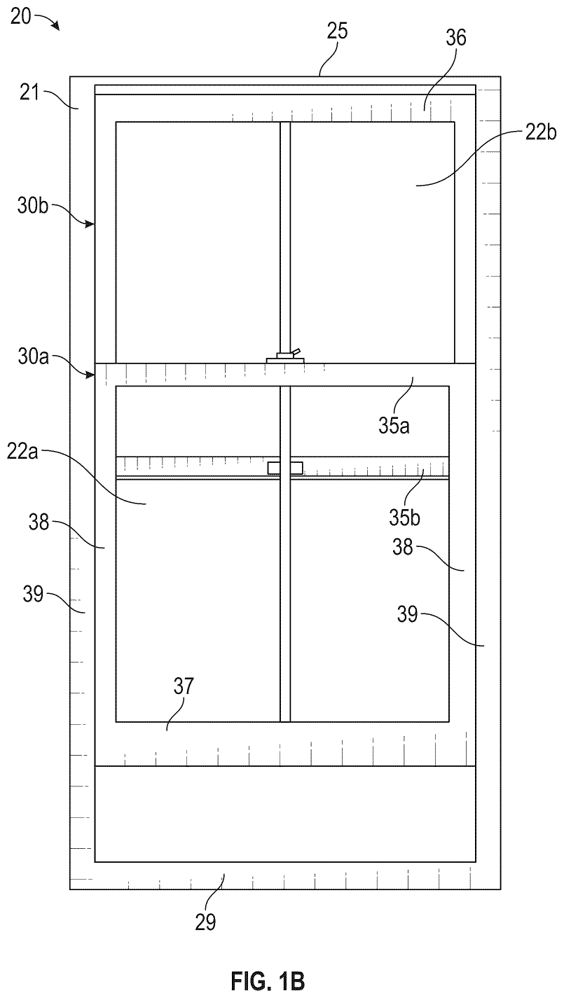

The door assembly shown in FIG. 1A is an example of a fenestration assembly 10 and includes a fenestration frame 11 and panel 12. The fenestration assembly 10 includes an example of the panel 12 as a sliding door. The fenestration assembly 10 includes, for example, a fenestration frame 11 with the panel 12 (e.g., a sliding panel) movably coupled with the frame. For example, the panel 12 translates along at least one or more of a top track 16a and a bottom track 16b. In this example, the top track 16a is positioned within a header 15 of the fenestration frame 11. The opposing bottom track 16b is positioned within the sill 19 of the fenestration frame 11.

The panel 12 is movable between open and closed positions, and intermediate positions therebetween. The fenestration assembly 10, in some examples, is considered opened or closed depending on the viewpoint of the user. For example, a door is considered open but not fully opened to the extent of the hinges, guides, tracks or the like. Alternatively, a door is closed but not shut, such as retracted from a portion of the frame but not completely open (e.g., to a position most remote from the portion of the frame).

In an example, the panel 12 moves (e.g., slides, translates, or the like) along the top track 16a and the opposing bottom track 16b. For instance, the panel 12 includes a top rail 17a that is cooperatively engaged with the top track 16a. In another example, a bottom rail 17b is cooperatively engaged with the opposing bottom track 16b. The panel 12 is movable (e.g., slides, translates, rolls or the like) from a closed position to an open position, and intermediate positions therebetween. For instance, in the closed position, a first stile 18a of the panel 12 is in contact (e.g., in communication, touching, proximate, slightly removed, or the like) with a first jamb 14a of the fenestration frame 11. In the open position, an opposing second stile 18b of the panel 12 is proximate an opposing jamb 14b of the fenestration frame 11 in comparison to the panel 12 in the closed position (e.g., shown in FIG. 1A).

Illustrated in FIG. 1B is an example of a fenestration assembly 20 including a window assembly. The fenestration assembly 20 includes a fenestration frame 21 and a first (lower) fenestration sash 30a and a second (upper) fenestration sash 30b positioned therein. The first sash 30a includes stiles 38, a bottom rail 37 and a first check rail 35a. The second fenestration sash 30b includes, for example, a second check rail 35b and a top rail 36. Optionally, positioned within the first sash 30a are one or more panes 22a and positioned within the second sash 30b are one or more panes 22b.

At least one or more of the first sash 30a or second sash 30b are formed to transition from a closed position to an open position, from an open position to a closed position, and through intermediate positions therebetween. A window, in some examples, is considered opened or closed depending on the viewpoint of the user. For example, a window is considered open but not fully opened to the extent of the guides or hinges and may also be considered closed but not shut. In an example, at least one of the first sash 30a or the second sash 30b moves (e.g., slides, translates, or the like) along jambs 39 in the manner of a single or double hung window. The jambs 39 extend between, for example, a header 25 and a sill 29. For example, the first sash 30a and the second sash 30b are each cooperatively engaged with the jambs 39 to move (e.g., slide, translate or the like) between a closed position and an opened position, and through intermediate positions therebetween. In the closed position, the bottom rail 37 of the first sash 30a is, for instance, in contact (e.g., in communication, touching, slightly removed, or the like) with the sill 29 of the fenestration frame 21. In an example, in the open position, the first check rail 35a of the first sash 30a is proximate to the header 25 of the fenestration frame 21 in comparison to the first sash 30a in a closed position.

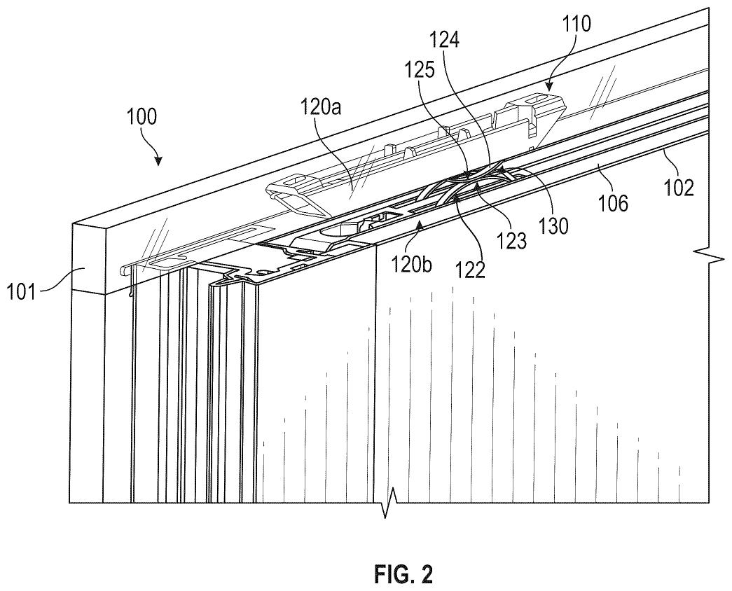

FIG. 2 illustrates a perspective view of an example of a portion of a fenestration assembly 100 including an interface assembly 110 that provides one or more of electrical or data communication between components of the fenestration assembly 100, such as the fenestration frame 101 and the panel 102. As shown, the fenestration assembly 100 includes the fenestration frame 101 and the fenestration panel 102 movably coupled with the frame. For instance, the fenestration panel 102 is movably coupled with the fenestration frame 101 and transitions between the open position and the closed position, including positions therebetween (e.g., intermediate static positions or intermediate positions while moving). For example, the fenestration panel 102 is positioned within the fenestration frame 101 to move (e.g., slide, glide, translate, roll or the like) along a top track and bottom track (as discussed in the description related to FIG. 1A) or stiles (as discussed in the description related to FIG. 1B).

The interface assembly 110 is coupled with the fenestration assembly 100. The interface assembly 110 includes components that permit electrical communication (e.g., one or more of power or data transmission) between the fenestration frame 101 and the fenestration panel 102. For example, the interface assembly 110 permits continuous electrical communication (e.g., power or data transmission) with the fenestration panel 102 (e.g., door panel or sash as discussed in the description related to FIGS. 1A and 1B) in various positions relative to the fenestration frame 101. For instance, the interface assembly 110 includes conductive components, described herein, that permit power or data transmission through one or more of an opened position, closed position, or positions therebetween. Communication is facilitated both when the fenestration panel 102 is static and while the fenestration panel 102 is in motion. In another example, communication provided with the interface assembly 110 is continuous (e.g., unbroken, including near continuous with abbreviated interruptions, or the like) while the fenestration 102 is in any of the positions noted herein, while moving, while static, or the like.

The interface assembly 110 in FIG. 2 is coupled along at least portions of the fenestration frame 101. For example, the interface assembly 110 is coupled laterally along the fenestration frame 101. In an example, the interface assembly 110 is positioned in various arrangements along the fenestration frame 101 relative to movable (e.g., slidable, translatable, or the like) portions of the fenestration panel 102 (e.g., panels, sashes, or the like). For example, the interface assembly is positioned along one or more of the jambs, sills, stiles, rails or the like). The interface assembly 110 is coupled with, for example, a panel rail 106 of the fenestration panel 102 and also with the fenestration frame 101.

The interface assembly 110 includes, for example, an interface housing 120, one or more bridge contacts 122 and one or more opposed contacts 124. The one or more bridge contacts 122 are coupled with the panel 102 and the one or more opposed contacts are coupled with the fenestration frame 101. In another example, the bridge contacts 122 and opposed contacts 124 are inverted, with the bridge contacts 122 coupled along the fenestration frame 101 and the opposed contacts along the panel 102.

In some instances, the one or more opposed contacts 124 has the form of a plurality of a bridge contacts. The one or more opposed contacts 124, in some examples, include an opposed crest segment 125. In other examples, the one or more opposed contact are elongate contacts having associated elongate segments that permit extended engagement between contacts. In another example, the one or more opposed contacts 124 are a combination of a crest segment, a trough segment, and elongate segments, as discussed in the description related to one or more of FIGS. 2-11B.

While the one or more bridge contacts 122 and the one or more opposed contacts 124 are discussed herein in an orientation with the one or more bridge contacts 122 coupled with the panel rail 106 of the fenestration panel 102, and the one or more opposed contacts 124 coupled with the fenestration frame 101, the orientation, in some examples, is reversed. For instance, the opposed contact 124 coupled with the fenestration frame 101 and has a form of a bridge contact. Further, for instance, the opposed contact coupled with the panel rail 106 includes an elongate contact.

The one or more bridge contacts 122 and the one or more opposed contacts 124 are conductive. For instance, each of the bridge contacts 122 and the opposed contacts 124 include conductive materials. In various examples, the bridge contacts 122 and the opposed contacts include a metal, such as, but not limited to, aluminum, copper, gold, alloys, or the like.

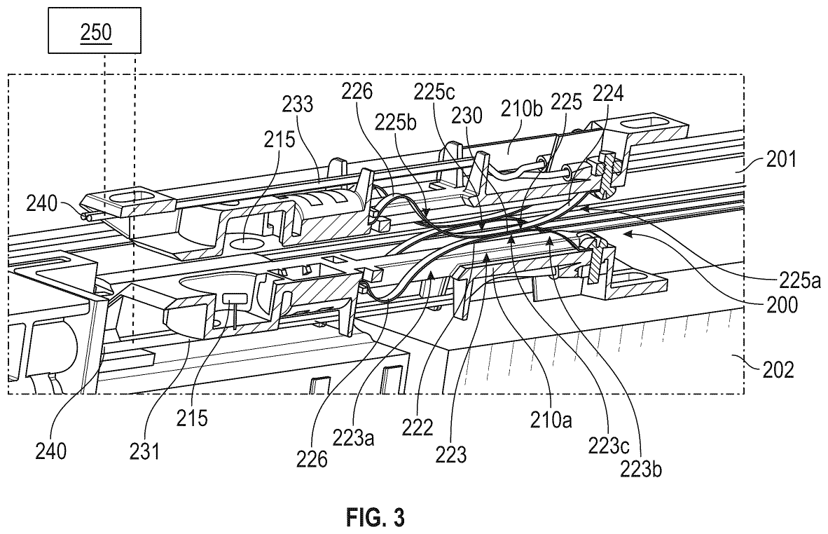

An interface 130 between the one or more bridge contacts 122 and the one or more opposed contacts 124 provides, for example, a point of contact for electrical communication between each of the bridge contacts 122 and the opposed contact 124. In an example, each of the bridge contacts 122 and the opposed contact 124 are at least partially engaged in mechanical and corresponding electrical communication at the interface 130 shown in FIG. 2. Wiring is positioned within at least one or more of the interface housing 120, the fenestration panel 102 or fenestration frame 101 to interconnect the contacts 122, 124 with sources of data, power or the like. The wiring, as discussed in the description related to FIG. 3, allows transmission of one or more of data or power from a source such as a processor, modem, router, sensor, motor or battery to the fenestration assembly 100 while the at least one of the bridge contacts 122 or the opposed contacts 124 permit the delivery of at least one of data or power to the fenestration panel 102. Further, the bridge contact 122 and the opposed contact 124 permit the delivery of data, for instance from one or more sensors associated with the panel 102, to other components, such as the processor, modem, router, or the like as described above.

In an example, the interface assembly 110 includes a first interface housing 120a and a second interface housing 120b. The first interface housing 120a and the second interface housing 120b are coupled (e.g., installed, recessed, or otherwise connected) with one of the fenestration frame 201 or the fenestration panel 202. The first interface housing 120a or the second interface housing 120b, in some instances, includes the bridge contacts 122 while the other housing 120a, 120b includes the opposed contacts 124.

The interface housing 120 is, for example, retained within a recess (e.g., cavity, opening, or the like) of the fenestration frame 101 or the fenestration panel 102. The interface housing 120 is optionally coupled with the fenestration frame 101 or the fenestration panel 102, for instance with an adhesive, fastener or the like. Optionally, the interface housing 120 is snap-fit, interference-fit, or otherwise coupled with one or both of the fenestration frame 101 or the fenestration panel 102.

As illustrated in FIG. 2, the bridge contacts 122 are retained within the interface housing 120. For example, at least a portion of the one or more bridge contacts 122 is exposed relative to the interface housing 120. For example, portions of the one or more bridge contacts 122 are exposed, such as the crest segment 123.

At least the crest segment 123 of the bridge contact 122 is deformable. The crest segment 123 of the bridge contact 122 is, for example, deformably engaged with the opposed contact 124 (e.g., a bridge contact opposed to the bridge contact 122). For instance, the crest segment 123 of the bridge contact 122 is deformably engaged with the opposed crest segment 125 of the opposed contact 124.

Illustrated in FIG. 3 is a cross section of another example interface assembly 200. The interface assembly 200 is coupled with the fenestration frame 201 and fenestration panel 202 (similarly discussed in the description related to FIG. 1A, 1B or 2). The interface assembly 200 includes a first interface housing 210a and a second interface housing 210b. Optionally, the first interface housing 210a is coupled with fenestration panel 202 (as discussed in the description related to FIGS. 1A, 1B and 2) and the second interface housing 210b is coupled with the fenestration frame 201 (as discussed in the description related to FIGS. 1A, 1B and 2).

The first interface housing 210a includes one or more bridge contacts 222. The bridge contacts 222 are similar to the bridge contacts 122 discussed related to FIG. 2. The second interface housing 210b includes an opposed contact 224 (e.g., bridge contact, elongate contact, angled contact, a combination of contacts, or the like). The opposed contact 224 is similar in at least some regards to the opposed contact 124 discussed related to FIG. 2. As in previous examples, the bridge contact 222 and the opposed contact 224 are positioned on the respective fenestration panel 202 and the fenestration frame 201. In another example, the bridge contacts 222 and opposed contacts 224 are inverted, with the bridge contact coupled with the fenestration frame 201 and the opposed contact coupled with the panel 202. While one bridge contact 222 and one opposed contact 224 are illustrated in FIG. 3, in other examples a plurality of the bridge contacts 222 or a plurality of the opposed contacts 224 are included with the interface assembly 200, for instance coupled along one or both of the fenestration frame 201 or the fenestration panel 202.

In an example, each bridge contact 222 includes a deformable bridge contact. The bridge contact 222 includes at least one crest segment 223 extending between a first crest end portion 223a and a second crest end portion 223b. Positioned between the first end portion 223a and the second crest end portion 223b is a crest apex 223c. The crest apex 223c includes, for instance, a position along the crest segment 223 having the greatest amplitude. The at least one crest segment 223 deformably engages with the opposed contact 224. For instance, the at least one crest segment 223 deforms (e.g., depresses, alters the profile of or the like) when engaged with (e.g., connects, contacts, touches, directly or indirectly, or the like) the opposed contact 224, such as against the opposed crest segment 225 of the contact 224. For instance, engagement includes deformable engagement and lateral distribution of the bridge contact 222 while the fenestration panel 202 is in various static positions or a moving configuration. In examples, deformation is laterally distributed along the bridge contact 222 (e.g., in a distributed, surface-to-surface manner, or the like), to permit continuous engagement with the opposed contact 224.

The opposed contact 224, in an example, is optionally an opposed deformable bridge contact. The opposed contact 224, as an opposed deformable bridge contact, includes an opposed crest segment 225 with a first opposed end portion 225a and a second opposed end portion 225b. An opposed apex 225c or peak of the opposed contact 224 is disposed between the first opposed end portion 225a and the second opposed end portion 225b. The opposed contact 224, as an opposed bridge contact, in some examples, is cooperatively deformed along with the bridge contact 222 to provide a laterally distributed (e.g., surface-to-surface) engagement therebetween.

The bridge contact 222 and the opposed contact 224 engage at an interface 230 shown in FIG. 3. The interface 230 provides a point of contact for electrical communication (e.g., power, data, or the like) between the bridge contact 222 and the opposed contact 224. For instance, wiring 240 is positioned within the first interface housing 210a, the second interface housing 210b or within the fenestration frame 201 or fenestration panel 202. The wiring 240 transmits, for example, electrical communication (e.g., power or data) from the interface assembly 200 (e.g., across the interface 230) to an external source 250 such as a processor, modem, router, sensor, or motor.

In examples, a first wiring system 231 is positioned or extends within the first interface housing 210a. The first wiring system 231 extends, for instance, through channels, passages, routes or the like. The first wiring system 231 transmits an electrical communication (e.g., data or power) to the bridge contact 222. In some examples, the first wiring system 231 transmits an electrical communication to or from the bridge contact 222 to the external source 250.

In another example, a second wiring system 233 is positioned or extends within the second interface housing 210b. For instance, the second wiring system 233 extends through wiring channels, passages, routes or the like. The second wiring system 233 transmits an electrical communication (e.g., data or power) to the opposed contact 224. In some examples, the second wiring system 233 transmits an electrical communication to or from the opposed contact 224 to the external source 250. For instance, electrical communication is transmitted between the bridge contact 222 to the opposed contact 224 when the bridge contact 222 is in contact or engaged with the opposed contact 224.

In an example, the first wiring system 231 is in communication with the external source 250 to transmit one of power or data to the bridge contact 222. Optionally, the external source 250 provides power, data, or both power and data to the bridge contact 222. For instance, the external source 250 provides power to the first wiring system 231 to assist with maintaining power for operation of data transmission. The external source 250 optionally provides data to or receives data from the bridge contact 222. In an example, the data transmitted to or from the bridge contact 222 relates to a position or movement of the fenestration panel 202 relative to the fenestration frame 201. In another example, the external source 250 transmits or receives data to or from the bridge contact 222 related to a characteristic (e.g., opaqueness, shading, temperature, hardware position, or the like) of the fenestration panel 202.

In another example, the second wiring system 233 of the second interface housing 210b is in communication with the external source 250 to transmit one of power or data to the opposed contact 224. Optionally, the external source 250 provides power to the opposed contact 224.

For instance, power is transmitted from the external source 250 to the opposed contact 224 to permit selective or continuous transmission of data to the opposed contact 224 or the interface assembly 200. Selective or continuous data transmission is optionally both to and from the opposed contact 224 and the external source 250. In one example, the selective data transmission occurs when a certain activity is recognized between the fenestration frame 201 and the fenestration panel 202. For example, data is selectively transmitted between the bridge contact 222 and the opposed contact when the fenestration panel 202 is moved relative to the fenestration frame. Optionally, continuous data transmission occurs to recognize the status of the fenestration panel 202 relative to the fenestration frame 201. For example, continuous power or data transmission is implemented to continuously monitor the position fenestration panel 202, such as is in a closed position versus, open position or positions therebetween.

In one example, one or more of the first interface housing 210a or the second interface housing 210b includes a sensor 215 and, optionally, components for sensor operation. For instance, the sensor 215 is in communication with the first wiring system 231 or the second wiring system 233. In another example, the sensor 215 is a wireless sensor. Optionally, the sensor 215 is an active sensor or a passive sensor. In another example, the sensor includes a reed switch positioned in one of the first interface housing 210a or the second interface housing 210b and an opposing magnet is positioned within the other of the first interface housing 210a or the second interface housing 210b. The sensor 215 in another example is an optical sensor that is either wireless, separately wired or coupled with the wiring 240. In an example, the sensor 215 is used to detect, measure, sense or the like a position of the fenestration assembly.

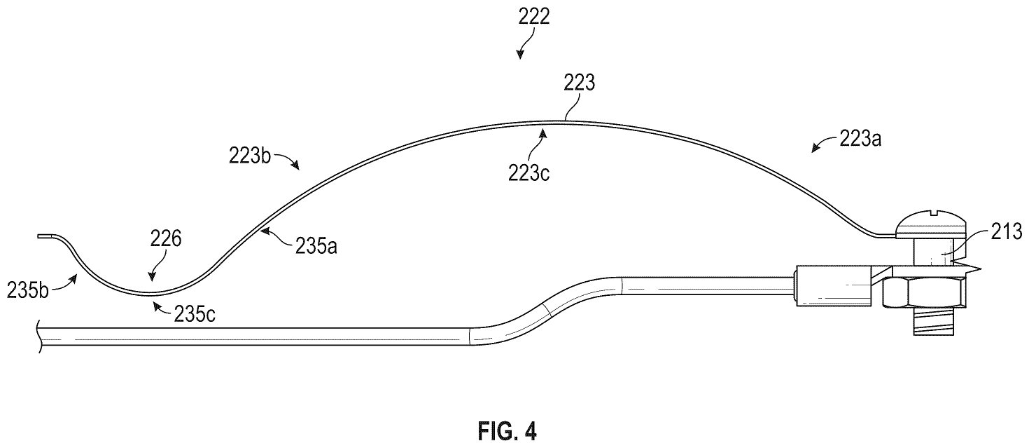

Illustrated in FIG. 4 is an example of the bridge contact 222 or the opposed contact 224 as a bridge contact. In an example a large proportion (e.g., such as greater than 50 percent, greater than 75 percent or more) of the at least one crest segment 223 is configured for engagement and transmission with the opposed contact 224. The bridge contact 222 has, for example, an elongate profile that extends in wave-like fashion between the first crest end portion 223a and second crest end portion 223b.

The bridge contact 222 includes at least one crest segment 223 extending between a first crest end portion 223a and a second crest end portion 223b. The at least one crest segment 223, in an example, includes an apex 223c (e.g., peak) positioned along the at least one crest segment 223. For instance, the apex 223c is centrally positioned between the first crest end portion 223a and the second crest end portion 223b. In another example, the apex 223c is positioned closer to one of the first crest end portion 223a or the second crest end portion 223b.

In an example, a trough segment 226 extends continuously from the second crest end portion 223b. The trough segment 226, in examples, is a reciprocal bias have elastic properties. For example, elasticity of the trough segment 226 mechanically opposes deformation of the at least one crest segment 223. The trough segment 226, in examples, drives contact of the at least one crest segment 223 into affirmative engagement, when the bridge contact 222 contacts or engages the opposed contact 224 (as the opposed contact was discussed related to FIG. 3). In examples, reciprocal bias of the trough segment 226 promotes smooth movement (e.g., translation, slide, or the like) and more consistent engagement between the at least one crest segment 223 and the opposed contact 224.

The trough segment 226 extends, in examples, from a first trough end portion 235a to a second trough end portion 235b. The first trough end portion 235a in some examples extends from the second crest end portion 223b. In another example, the first trough end portion 235a is otherwise coupled with the second crest end portion 223b to transfer a reciprocal bias. Between the first trough end portion 235a and the second trough end portion 235b is a valley 235c. The valley 235c includes, for example, the bottommost portion of the trough segment 226. A portion of the second trough end portion 235b of the trough segment 226 is coupled with at least one of the first interface housing 210a or second interface housing 210b, interface assembly 200, fenestration panel 202 or fenestration frame 201 (as discussed in the disclosure related to FIG. 2 or 3). In examples, a portion of the trough segment 226 is coupled with a fastener 213, such as a screw, bolt, terminal, plug, or the like.

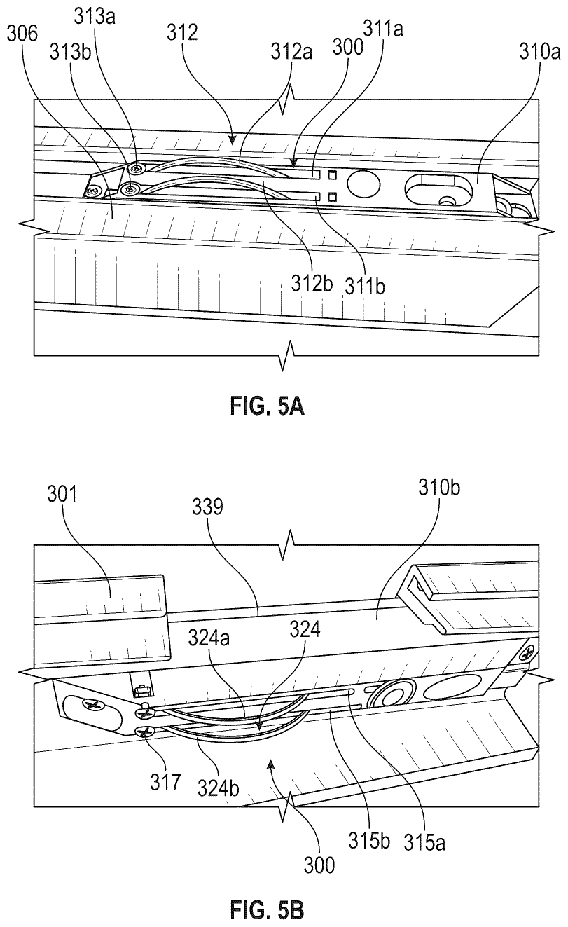

Illustrated in FIGS. 5A and 5B, are examples of each of the bridge contact 312 and an opposed bridge contact 324 of an interface assembly 300. For example, illustrated in FIG. 5A is an example of a bridge contact 312 positioned relative to a top rail 306. The bridge contact 312, as illustrated in FIG. 5A, is positioned (e.g., retained, held, confined or the like) within a first interface housing 310a. In an example, the first interface housing 310a is positioned along the top rail 306. For instance, the first interface housing 310a is coupled with or within a portion of the top rail 306.

As illustrated in FIG. 5A, the bridge contact 312 includes a first bridge contact 312a and a second bridge contact 312b. The first bridge contact 312a and the second bridge contact 312b are positioned next to each other along the fenestration rail 306. Optionally, the first bridge contact 312a and the second bridge contact 312b are positioned adjacent (e.g., parallel, slightly angled, or the like) to each other along the fenestration rail 306.

In an example, each of the first bridge contact 312a and the second bridge contact 312b protrudes or extends from the first interface housing 310a through a first slot 311a or a second slot 311b (e.g., recess, cavity, indentation or the like), respectively. Each of the slots 311a, 311b, for instance, permits exposure of a portion of the first bridge contact 312a, 312b while providing protection for the remainder of each of the bridge contacts 312a, 312b from environmental conditions. Optionally, each of the bridge contacts 312a, 312b are retained in position with the first interface housing 310a with one or more fasteners 313a. 313b. In another instance, each of the bridge contacts 312a, are retained in position with the first interface housing 310a with an adhesive, welding or the like.

FIG. 5B illustrates an example of an opposed contact 324 positioned relative to a fenestration frame 301, such as a jamb 339. The opposed contact 324, in the example of FIG. 5B, is an opposing bridge contact. Similar to the bridge contact 312 of FIG. 5A, opposed contact 324 includes a first opposed bridge contact 324a and a second opposed bridge contact 324b. Optionally, each of the first opposed bridge contact 324a and the second opposed bridge contact 324b is positioned (e.g., retained, held, confined or the like) within a second interface housing 310b. The second interface housing 310b is optionally coupled with the fenestration frame 301. For example, the second interface housing 310b is coupled with the jamb 339. In another example, the second interface housing 310b is positioned within a recess formed in the fenestration frame 301.

In an example, the second interface housing 310b includes one or more opposed slots 315a, 315b. The each of the first opposed bridge contact 324a and the second opposed bridge contact 324b optionally protrudes, extends or the like from the one or more opposed slots 315a, 315b, respectively. In an example, a first opposed contact 324a and a second opposed contact 324b are each positioned in an associated slot of the one or more opposed slots 315a, 315b. The one or more opposed slots 315 are, for example, similar to the slots 311a, 311b, as discussed related to FIG. 5A. For instance, the second interface housing 310b includes one or more opposed slots 315 permitting exposure of a portion of the first opposed bridge contact 324a and the second opposed bridge contact 324b. The second interface housing 310b is designed to protect remaining portions of the first opposed bridge contact 324a or the second opposed bridge contact 324b. In an example, the second interface housing 310b maintains the position of the first opposed bridge contact 324a and the second opposed bridge contact 324b relative to the fenestration frame 301 or the jamb 339. Optionally, each of the opposed bridge contacts 324a, 324b is coupled to the second interface housing 310b with one or more fasteners 317. In another instance, each of the opposed bridge contacts 324a, 324b are coupled with the second interface housing 310b with an adhesive, welding or the like.

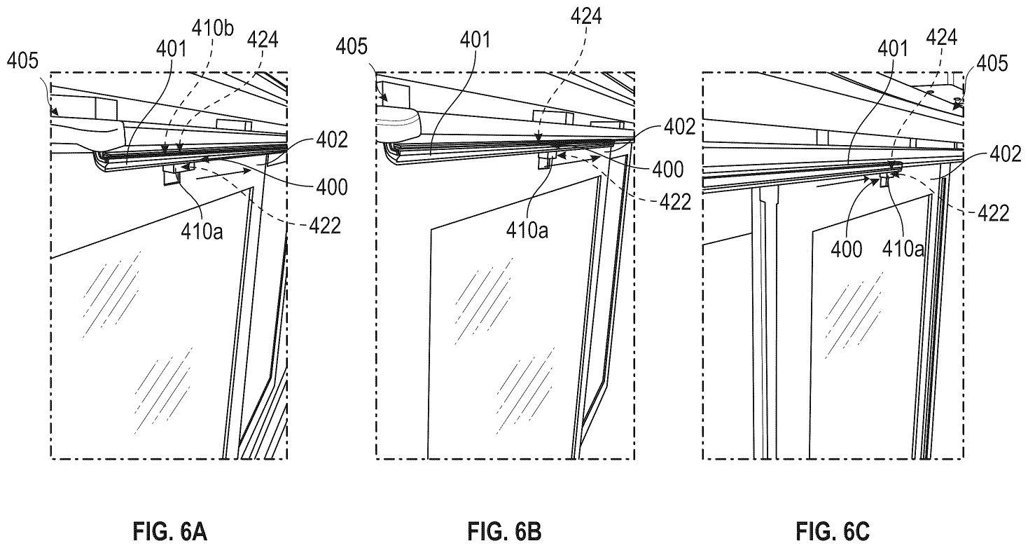

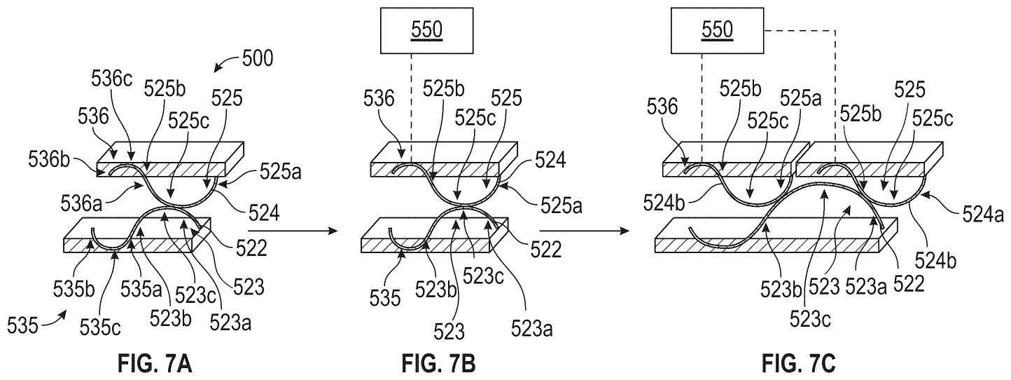

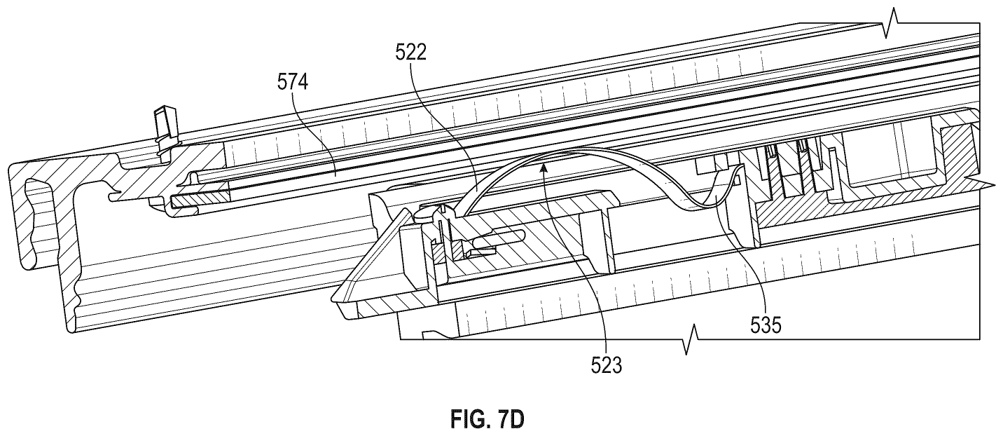

FIGS. 6A, 6B and 6C illustrate relative movement of components of an interface assembly 400 and fenestration assembly 405. FIGS. 7A, 7B and 7C are schematic illustrations of the interface between a bridge contact and an opposing contact as an interface assembly (such as interface assembly 400) progressively moves (e.g., translates, slides, or the like) through the example positions shown in in FIGS. 6A, 6B and 6C. For example, FIGS. 6A-6C illustrate the fenestration assembly 405 and interface assembly 400 moving, respectively, for an open position to a closed position and intermediate positions therebetween. FIGS. 7A-7C illustrate the interface assembly 400 as it transitions from the open position to the closed position, including intermediate positions therebetween.

The interface assembly 400 in FIG. 6A includes a first interface housing 410a and one or more opposed contacts 424 (hidden here and revealed in FIGS. 7A-C). The first interface housing 410a is coupled to, for example, a fenestration panel 402. Optionally, the one or more opposed contacts 424 are positioned within a fenestration frame 401. In an example, the one or more opposed contacts 424 are positioned (e.g., retained, held, installed, housed or the like) in one or more second interface housings 410b (similar to the second interface housing discussed related to FIG. 3, 5A or 5B) within a fenestration frame 401.

In an example, FIG. 6A represents an initial position, such as a closed position, of the fenestration panel 402 relative to the fenestration frame 401. In the closed position, the fenestration panel 402 is in contact or almost in contact (e.g., 5 centimeters away, 2 centimeters away, less than 1 centimeter away) with a stile, sill, jamb, or fenestration frame. The first interface housing 410a retains a bridge contact 422 along the fenestration panel 402. The bridge contact 422, in some examples, is similar to the bridge contact discussed in the description related to FIGS. 2-5B. The bridge contact 422 is in electrical contact with the one or more opposed contacts 424 associated with the fenestration frame 401.

FIG. 6B illustrates an example of the fenestration assembly 405 with the panel 402 moved relative to the fenestration frame 401 and relative to the view shown in FIG. 6A (e.g., translated, slid or the like). For example, the fenestration panel 402 is transitioning from a closed position (FIG. 6A) toward an open position (FIG. 6C). In another example, the fenestration panel 402 is moving through one or more intermediate positions between the open position and the closed position. While the fenestration panel 402 translates, the bridge contact 422 of the fenestration panel 402 is in contact and provides communication with the opposing contact 424 of the fenestration frame 401.

FIG. 6C shows the fenestration panel 402 in an open position, sometimes referred to as a second position, relative to the fenestration frame 401. For example, the first interface housing 410a coupled with the fenestration panel 402 is remote relative to a portion of the fenestration frame 401 (e.g., a jamb) in comparison to the closed position shown in FIG. 6A. While FIG. 6C illustrates the fenestration panel 402 in an open position (e.g., at or proximate to a maximum displacement), the open position optionally includes fenestration panel 402 positions proximate to the closed position. For instance, the fenestration panel 402 is ‘open’ when moved a relatively small distance from fully closed in FIG. 6A, for instance 5 centimeters, 2 centimeters, less than 1 centimeter from the jamb of the frame 401.

In examples, the bridge contact 422 associated with the fenestration panel 402 (optionally retained in the first interface housing 410a) is in contact and communication with the opposing contact 424 of the fenestration frame 401. For instance, the bridge contact 422 of the frame 401 is in continuous contact (including near continuous contact) with the opposing contact 424 (of the panel 402) to ensure continuous communication between the bridge contacts 422 and the opposing contact 424 and from the panel 402 to the frame 401.

FIGS. 7A, 7B and 7C are schematic views of progressive movement of an interface assembly 500 as an associated fenestration assembly 505 moves. As discussed herein, the interface assembly 500 maintaining electrical communication between the fenestration panel 402 and fenestration frame 401 of the fenestration assembly 505. As previously described, and similarly illustrated in FIGS. 7A-C, the interface assembly 500 includes one or more bridge contacts 522 and opposed contacts 524. In the example illustrated in FIGS. 7A, 7B and 7C the opposed contact 524 is a bridge contact similar to the bridge contact 522.

FIG. 7A illustrates an example initial position of the interface assembly 500 with the associated fenestration panel proximate to the fenestration frame (similar to the fenestration frames discussed relative to FIG. 2, 3, 5A, 5B, 6A, 6B or 6C). In the example initial position includes the location of the panel (e.g., door panel, window sash or the like) at a position relative to the fenestration frame (e.g., closed, open, an intermediate position, or the like).

FIG. 7A shows the bridge contact 522 associated with the panel (e.g., door panel, window sash or the like) and positioned relative to the opposed contact 524. As discussed herein, the bridge contact 522 remains in contact with the opposed contact 524 as the fenestration panel and its bridge contact 522 transitions between the closed position, open position, positions therebetween, and the like.

One or both of the bridge contact 522 or the opposed contact 524 is deformably engaged with the other of the opposed contact 524 or the bridge contact 522. For example, as discussed herein the deformable engagement (of one or both contacts) includes a distributed, lateral deformation that maintains communication between the bridge contact 522 and the opposed contact 524. For instance, a portion of a crest segment 523 of the bridge contact 522 is deformably engaged and in contact with an opposed crest segment 525 of the opposed contact 524. In this example, the crest segment 523 and the opposed crest segment 525 apply a compressive force to each other that deforms one or both of the crest segments 523 and the opposed crest 525 and maintains contact and corresponding communication (e.g., electrical, data, both or the like) therebetween.

As illustrated in FIG. 7A is an example initial configuration the bridge contact 522 engages with the opposed contact 524 and the engagement compresses and laterally deforms the bridge contact 522 and the opposed contact 524 to provide a consistent, distributed contact. A lateral distribution of electrical contact is in some examples promoted with a reciprocal bias responsive to engagement of the crest segment 525) to the crest segment 525 through a trough segment 535 of the bridge contact 522. In the example interface assembly 500, the trough segment 535 of the bridge contact 522 is positioned in an opposing position relative to the opposed crest segment 525. In the interface assembly 500, an opposed a trough segment 536 is in an opposing position to the opposed crest segment 525. The trough segment 535 and the opposed trough segment 536, for example, each provide a reciprocal bias to the respective crest segment 523 or the opposed crest segment 525 upon engagement between the bridge contact 522 and the opposed contact 524. In various examples, the reciprocal bias provided by the trough segment 535 and the opposed trough segment 536 and applied to the crest segment 523 and the opposed crest segment 525 corresponds with the engagement of the crest segments 523 and the opposed crest segment 525. Accordingly, the crest segment deformation and reciprocal bias provided by the trough segments 53 and the opposed trough segment 536 cooperate to maintain reliable communication between the bridge contact 522 and the opposed contact 524.

In examples, the trough segment 535 extends from a first trough end portion 535a to a second trough end portion 535b with a valley 535c (e.g., a trough) therebetween. In some examples, the opposed contact 524, as a bridge contact, includes an opposed trough segment 536 extending from a first opposed trough end portion 536a to a second opposed trough end portion 536b with an opposed valley 536c therebetween. In examples, the trough segment 535 and the opposed trough segment 536 include the first trough end portion 535a or the first opposed trough end portion 536a that transitions to a second crest end portion 523b or a second crest end portion 525b or is otherwise coupled with the crest segment 523 or the opposed crest segment 525, respectively to transfer the reciprocal bias.

The bridge contact 522 is in electrical contact with the opposed contact 524. The electrical contact between the bridge contact 522 and the opposed contact 524 provides electrical communication between the bridge contact 522 and the opposed contact 524. For example, the bridge contact 522 engaged with the opposed contact 524 and deformation of the associated portions of the contacts laterally distributes electrical contact along one or more of the bridge contact 522 or the opposed contact 524. For instance, the lateral distribution of electrical contact through deformation promotes an elongate surface to surface engagement between the contacts. In one example, the reciprocal bias from the trough segments 535 is applied to the bridge contact 522 (e.g., its crest segment) due to the contact from the opposed contact 524 to promote deformation of the contact 522 and laterally distribute engagement between the contacts 522, 524 for a reliable extend connection. The reciprocal bias is applied to the bridge contact 522 according to the deformation of the bridge contact 522, such as the location of deformation, quantity of deformation (e.g., compression, depression or the like) of the bridge contact 522 when engaged with the opposed contact 524.

The reciprocal bias applied to the crest segment 523 or the opposed crest segment 525 enhances engagement between the bridge contact 522 and the opposed contact 524 when the interface assembly 500 is in motion (e.g., moved, translated, slid, or the like) and stationary. For example, at least a portion of the bridge contact 522 depresses between the first crest end portion 523a and the second crest end portion 523b when the crest segment 523 of the bridge contact 522 engages with the opposed contact 524. The reciprocal bias is applied, for instance, from the trough segment 535 to at least a portion of the bridge contact 522 between the first crest end portion 523a and the second crest end portion 523b, including to a crest segment 523 of the bridge contact 522. Maintaining continuous engagement through cooperation between the trough segment 535 and crest segment 523 applies a reciprocal bias to the bridge contact 522 (e.g., between the first crest end portion 523a and the second crest end portion 523b), promotes lateral distribution of engagement, and enhances consistent electrical connection.

FIG. 7B further illustrates the continued engagement between the opposed contact 524 (e.g., as an opposing bridge contact) and the bridge contact 522. The panel moves from the first position to a second position (e.g., a position along the frame different from the first position) the bridge contact 522 of the panel moves (e.g., translates, slides, or the like) relative to the frame (see FIGS. 1A-6C). While engaged with the opposed contact 524 (also while moving) the crest segment 523 of the bridge contact 522 deforms (e.g., depresses, deflects or the like). In another example, both of the crest segment 523 and the opposed crest segment 525 of the respective bridge contact 522 and the opposed contact 524 depress against each other while the panel moves (or is stationary). For example, the opposed crest segment 525 and the crest segment 523 deform (e.g., depress or deflect) through their engagement.

In the example of FIG. 7B, the bridge contact 522 and the opposed contact 524 reliably maintain electrical connection therebetween (e.g., power or data transmission) through the continued engagement of the bridge contact 522 and the opposed contact 524. For example, the opposed crest segment 525 and the crest segment 523 including one or more locations positions along the opposed crest segment 525 or the crest segment 523, are depressed relative to the other in a relaxed state based on their engagement. In some situations, the crest segment 523 of the bridge contact 522 reciprocally deforms to the crest segment 525c of the contact 524 in response to the engagement between the contacts 522, 524. The bridge contact 522 reciprocally deforms when in contact with at least one of the first crest end portion 523a, second crest end portion 523b, or crest segment 523.

In examples, the trough segment 535 of the bridge contact 522 and the opposed trough segment 536 of the opposed contact 524 provide a reciprocal bias, respectively to each of the bridge contact 522 and the opposed contact 524. The reciprocal bias applied from the trough segment 535 and the opposed trough segment 536 enhances the connection between the bridge contact 522 and the opposed contact 524 by promoting deformation and distributed engagement therebetween as the bridge contact 522 moves relative to the opposed contact 524.

In one example, as the bridge contact 522 is moved (e.g., translated, slid or the like) relative to the opposed contact 524, data related to the position of the panel is transmitted. The electrical communication across the bridge contact 522 and the opposed contact 524 is transmitted from the opposed contact 524 to an external source 550 (e.g., control system, computer, processor or the like). The distributed engagement of the contacts 522, 524, described above, promotes the continued electrical communication and enhances reliability of the communication, for instance to provide high resolution position information of the panel (e.g., open, closed, intermediate positions therebetween), continuous information on systems of the panel, such as locks, security sensors, light sensors or the like. Optionally, the electrical communication is related to the position of a panel relative to a frame, a status of the panel or the like.

In the example illustrated in FIG. 7C, the bridge contact 522 is positioned between two opposed contacts 524a, 524b. For example, as the bridge contact 522 is moved towards, or into contact with the opposed contact 524, a first crest end portion 523a deforms against a second opposed crest portion 525b of the opposed contact 524 when the first crest end portion 523a engages with or contacts the second opposed crest portion 525b. For instance, at least one of opposed contacts 524a, 524b includes an opposed trough segment 536. The trough segment 526 of each of the opposed contact 524a, 524b provides a reciprocal bias to each of the associated opposed contact 524.

In the example of FIG. 7C, the bridge contact 522 and the opposed bridge contact 524 are in continuous electrical engagement as the 522 spans between two opposed contact 524. For instance, as the first crest end portion 523a is moved, the first crest end portion 523a remains in contact with the second opposed crest portion 525b, and the second crest end portion 523b remains engaged with the previous opposed contact 524 along a portion of first opposed crest segment 525a. In an example, the opposed trough segment 536 provides a reciprocal bias to the first opposed crest segment 525a to maintain the connection between the opposed crest segment 525 and the crest segment 523. The trough segment 535 of the bridge contact 522 provides a reciprocal bias to the second crest end portion 523b to maintain portions of the bridge contact 522 in contact with the opposed contact 524. For instance, a portion, or segment, of each of the bridge contact 522 or opposed contact 524 deforms to maintain contact in response to the engagement with the other of the bridge contact 522 or the opposed contact 524. Optionally, the crest segment 523 of the bridge contact 522, such as the portions of the crest segment 523 proximate to an apex 523c of the crest segment 523 are not in contact with either of the opposed contact 524 during movement of the bridge contact 522 relative to the opposed contact 524.

Connection, or engagement, between the first crest end portion 523a and the second crest end portion 523b with the respective portions of each adjacent opposed contact 524a, 524b provides continuous transmission of electrical communication as the bridge contact 522 moves (e.g., translates, slides or the like). For instance, as the bridge contact 522 moves (e.g., translates, slides or the like) relative to the frame (as discussed previously related to one or more of FIGS. 1A-6C), electrical connection is maintained because at least a portion of the bridge contact 522 is in contact, or engaged, with at least a portion of adjacent opposed contact 524 of the one or more opposed contacts 524a, 524b.

Illustrated in FIG. 7D, an elongate opposed contact 574 is illustrated as the opposed contact to the bridge contact 522. The elongate opposed contact 574, for example, extends from a first portion of the frame (as discussed in the disclosure related to one or more of FIGS. 1A-6C) to a second portion of the frame. For example, the elongate opposed contact 574 extends from an end portion of the frame to an opposing end portion of the frame. In an example, the bridge contact 522 is in contact with the elongate opposed contact 574 at or proximate to at least a portion of the crest segment 523 of the bridge contact 522.

The trough segment 535 of the bridge contact 522 provides a reciprocal bias to the crest segment 523 thereby maintaining continuous engagement between the crest segment 523 and the elongate opposed contact 574. Continuous engagement between the crest segment 523 and the elongate opposed contact 574 promotes continuous transmission of electrical communication (e.g., power or data transmission) between the bridge contact 522 and the elongate opposed contact 574.

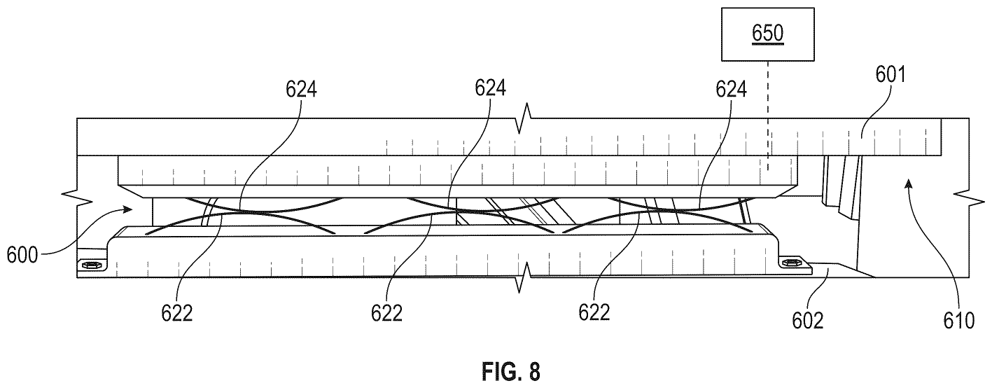

FIG. 8 illustrates another example of a fenestration assembly 610 including an interface assembly 600. The interface assembly 600 includes a plurality of deformable bridge contacts 622 arranged in series. The interface assembly 600 also includes a plurality of opposed contacts 624 arranged in series. The plurality of deformable bridge contacts 622 and the plurality of opposed contacts 624 illustrated in FIG. 8 are similar to the bridge contacts or opposed contacts previously discussed related to one or more of FIGS. 2-7C. While the plurality of opposed contacts 624 illustrated in FIG. 8 are bridge contacts, the plurality of opposed contacts 624, optionally includes an elongate contact.

In an example, the plurality of deformable bridge contacts 622 transmit one or more of power or data between a fenestration frame 601 or a fenestration panel 602 to the opposed contacts 624. In examples, including a plurality of deformable bridge contacts 622 in electrical contact with plurality of opposed contacts 624 reduces the wear on the components of the interface assembly 600. Reducing the wear on the components of the interface assembly 600, in some examples, enhances the longevity of continuous electrical connection between the plurality of deformable bridge contacts 622 and the plurality of opposed contacts 624.

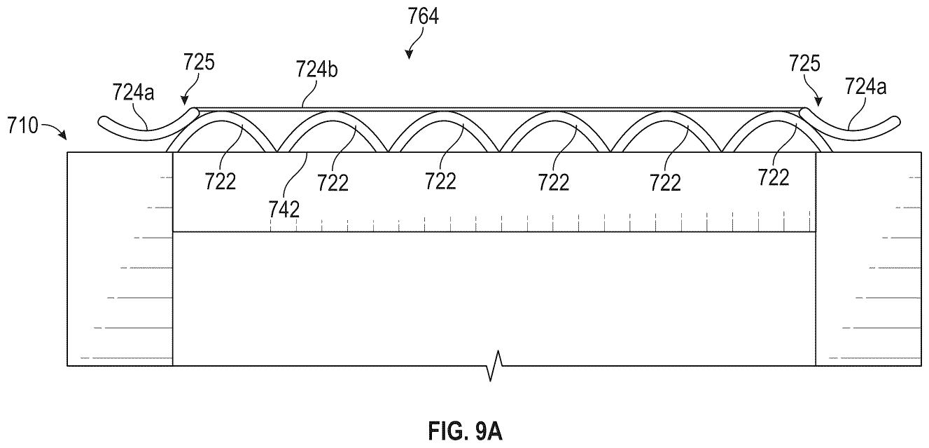

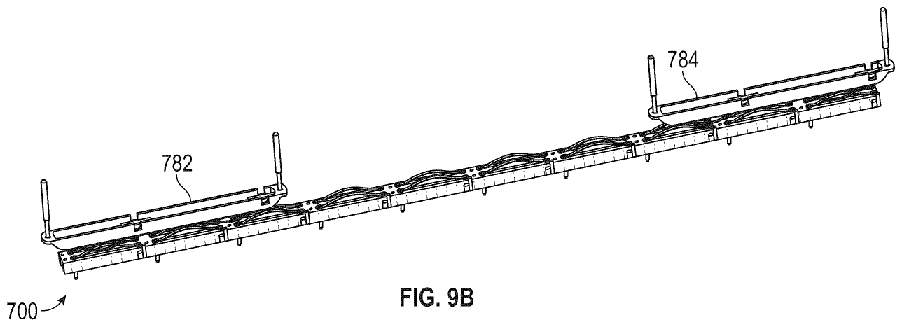

Illustrated in FIG. 9A, is another example of a fenestration assembly 710 that includes an interface assembly 700. In an example, one or more opposed contacts 764 is a composite assembly of at two opposed contacts 724a and an electrical transmitting wire 724b electrically connecting each of the opposed contacts 724a. Optionally, the opposed contact 724a is a bridge contact. In an example, the electrical transmitting wire 724b is coupled with at an end portion 725 of each of the opposed contacts 724a.

The electrical transmitting wire 724b, for instance, transmits electrical communication (e.g., power, data or the like) between each of the opposed contacts 724a. In an example, the opposed contacts 724a are continuously engaged with one or more bridge contacts 722 when at least one of the one or more bridge contacts 722 is in contact with each of the opposed contacts 724a. The one or more bridge contacts 722 are, for example, arranged in series to provide continuous electrical communication between each of the 722. In an example, the one or more bridge contacts 722 are each electrically connected to the next with a conductive material 742. Optionally, each of the one or more bridge contacts 722 transmit power or data from one bridge contact of the one or more bridge contacts 722 to the bridge contact of the one or more bridge contacts 722. In other examples, each of the one or more bridge contacts 722 are individually electrically connected with at least a portion of the one or more opposed contacts 764 to transmit at least one of data or power. In yet another example, each of the one or more bridge contacts 722 are connected in parallel. The one or more bridge contacts 722 are optionally connected in a combination of electrical arrangements.

Optionally, as illustrated in FIG. 9B, the interface assembly 700 includes a first opposing interface assembly 782 and a second opposing interface assembly 784. The first opposing interface assembly 782, for example, is in continuous electrical communication with the one or more bridge contacts 722 to provide one of power or data transmission. The second opposing interface assembly 784, for example, is in communication with the one or more bridge contacts 722 to provide the other of power or data transmission. Optionally, the second opposing interface assembly 784 provides a different, or second type, of data transmission to the one or more bridge contacts 722.

In an example, a portion of the interface assembly 700 neither receives or transmits power or data to the one or more bridge contacts 722. For example, in situations where power or data is not communicated between the bridge contacts 722 and the first opposing interface assembly 782 or second opposing interface assembly 784, the panel is positioned such that the one or more bridge contacts 722 are not in communication with either the first opposing interface assembly first opposing interface assembly 782 or the second opposing interface assembly 784. Optionally, the one or more bridge contacts 722 are positioned in contact with one of the first opposing interface assembly 782 or the second opposing interface assembly 784.

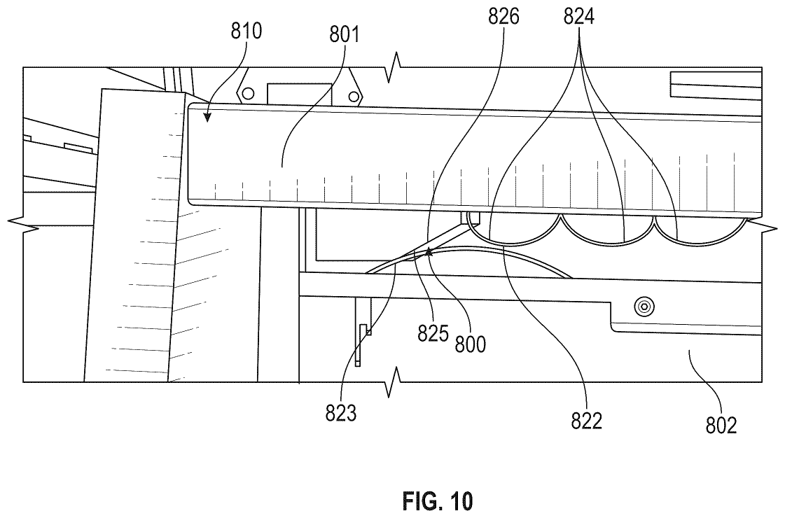

FIG. 10 illustrates another example of a fenestration assembly 810 including an interface assembly 800. The interface assembly 800 includes, for example, a first opposed contact 826 having a static taper portion 825. The static taper portion 825 is, for instance, positioned proximate at least one end 823 of a fenestration frame 801. The static taper portion 825, optionally, includes a continuous electrical connection. For example, the electrical connection within the static taper portion 825 transmits an electrical communication to one or more bridge contacts 822.

Optionally, one or more opposed contacts 824 provided along the fenestration frame 801. The one or more opposed contacts 824 are, for instance, electrically connected with the static taper portion 825. For instance, the one or more opposed contacts 824 continuously transmit an electrical communication (e.g., power or data) received from the static taper portion 825. The one or more opposed contacts 824 provide continuous electrical contact from the static taper portion 825 to the one or more bridge contacts 822.

The bridge contact 822 is, for example, a deformable bridge contact. At least a portion of the bridge contact 822, in an example, is depressed when the bridge contact 822 contacts the static taper portion 825. In an example, the static taper portion 825 engages with at least one end 823 of the bridge contact 822. The static taper portion 825, for instance, transmits one of power or data from one of the frame 801 or panel 802 to the other of the frame 801 or panel 802 through the connection between the static taper portion 825 and the bridge contact 822. While a taper is illustrated in this FIG. 10, other polygonal shapes are contemplated for use as an initial or final bridge contact.

In some instances, one or more opposed contacts 824 are included with the interface assembly 800. In an example, the opposed contacts 824 are in communication with the static taper portion 825. For instance, an electrical connection is continuously transmitted between the static taper portion 825 and the opposed contacts 824 as the panel 802 moves. As the panel 802 moves, the bridge contact 822 is in continuous contact with at least one of the opposed contacts 824.

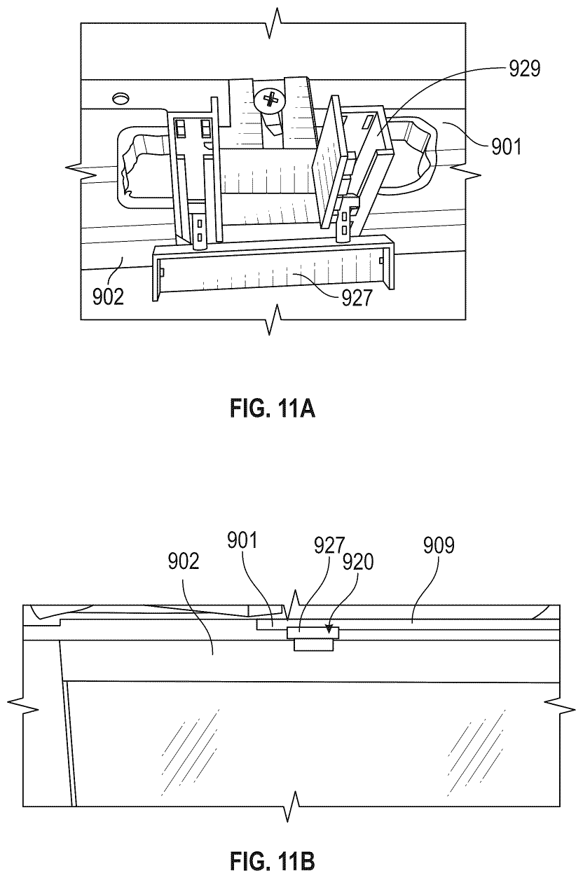

FIGS. 11A and 11B illustrate examples of an alternative interface housing 920 that, for example, are coupled with the panel 902. The alternative interface housing 920 includes, for instance, a carriage 927 and a track 929. The alternative interface housing 920, in examples, is coupled with a frame 901, such as proximate or along, a frame rail 909.

Illustrated in FIG. 11A, is an example, the carriage 927 is coupled with the panel 902 via the track 929 (e.g., keyway, rail, passage, groove). For instance, the track 929 is coupled (e.g., fastened, adhered or the like) with at least a portion of the panel 902. In an example, the alternative interface housing 920 includes the carriage 927 housing a bridge contact (such as the bridge contacts discussed in the disclosure related to one or more of FIGS. 2-10). For example, the carriage 927 retains the bridge contact. The carriage 927 retains the bridge contact relative to the frame 901, while the carriage 927 is repositioned according to the geometry or placement of the frame 901.

As illustrated in FIG. 11B, the carriage 927 is slidably coupled along the frame rail 909 and also movable relative to other coordinate directions. For example, if the frame rail 909 is longitudinally extending, the carriage 927 movably retains the bridge contact in the lateral or depth direction to maintain a continuous electrical connection between the bridge contact and an opposed contact (as discussed previously related to one or more of FIGS. 2-10).

The alternative interface housing 920 containing, for example, a bridge contact (as discussed related to one or more of FIGS. 2-10) is positioned within the carriage 927 and then the track 929 to maintain the position of the bridge contact relative to an opposing contact (as discussed related to one or more of FIGS. 2-10). For instance, the track 929, or other similar retention, allows the alternative interface housing 920 to be a floating coupling or a spring biased coupling, or a combination of those. This coupling allows the bridge contact to move in one or more of a vertical direction or a depth direction according to the orientation of one of the fenestration frame or fenestration panel. The design allows the carriage to “float” in the keyway on the panel. This allows the carriage to self-adjust in the X, Y, and Z axis.

In examples, the alternative interface housing 920 accounts for misalignment, settling or adjustment of the panel 902 relative to the frame 901. For example, the alternative interface housing 920 assists in maintaining contact between the opposed contact housed or retained by the frame 901 or the frame rail 909 and the bridge contact housed or retained by the carriage 927.

### Various Notes and Aspects

Aspect 1 can include subject matter, such as a fenestration assembly comprising: a fenestration frame; a fenestration panel movably coupled with the fenestration frame, wherein the fenestration panel is configured to move between an open position and a closed positions; and an interface assembly coupled between the fenestration frame and the fenestration panel, the interface assembly includes: one or more bridge contacts coupled with one of the fenestration frame or fenestration panel, the one or more bridge contacts include: a crest segment extending from a first crest end portion to a second crest end portion; and one or more opposed contacts coupled with the other of the fenestration panel or the fenestration frame; wherein the crest segment is deformably engaged with the one or more opposed contacts in each of the open and closed positions and intermediate positions therebetween.

Aspect 2 can include, or can optionally be combined with the subject matter of Aspect 1, to optionally include the one or more bridge contacts is a deformable, conductive interface.

Aspect 3 can include, or can optionally be combined with the subject matter of one or any combination of Aspects 1 or 2 to optionally include the crest segment deformably engaged with the one or more opposed contacts includes at least a portion of the crest segment is continuously deformably engaged.

Aspect 4 can include, or can optionally be combined with the subject matter of one or any combination of Aspects 1-3 to optionally include the one or more bridge contacts is a deformable and configured to provide a reciprocal bias distributed along each of the one or more bridge contacts toward the one or more opposed contacts.

Aspect 5 can include, or can optionally be combined with the subject matter of one or any combination of Aspects 1-4 to optionally include the crest segment is configured to be deformably engaged with the one or more opposed contacts includes deformable engagement and lateral distribution while the fenestration panel is in a moving configuration between the open and closed positions.

Aspect 6 can include, or can optionally be combined with the subject matter of one or any combination of Aspects 1-5 to optionally include the open position includes one or more of a fully open position and a partially open position; wherein in the closed position included one or more of a fully closed position and a partially closed position.

Aspect 7 can include, or can optionally be combined with the subject matter of one or any combination of Aspects 1-6 to optionally include the one or more bridge contacts is configured to transmit at least one of data or power between the fenestration frame and the fenestration panel.

Aspect 8 can include, or can optionally be combined with the subject matter of one or any combination of Aspects 1-7 to optionally include a trough segment coupled with crest and the trough segment is configured to provide a reciprocal mechanical bias.

Aspect 9 can include, or can optionally be combined with the subject matter of one or any combination of Aspects 1-8 to optionally include a reciprocal mechanical bias is opposed to deformation of the one or more bridge contacts.

Aspect 10 can include, or can optionally be combined with the subject matter of one or any combination of Aspects 1-9 to optionally include the one or more opposed contacts includes one or more opposed bridge contacts including: an opposed crest segment; and an opposed trough segment.

Aspect 11 can include, or can optionally be combined with the subject matter of one or any combination of Aspects 1-10 to optionally include the one or more opposed contacts includes an elongate strip contact, ribbon, or wire element.

Aspect 12 can include, or can optionally be combined with the subject matter of one or any combination of Aspects 1-11 to optionally include a plurality of bridge contacts arranged in series along one of the fenestration frame or the fenestration panel; and a plurality of opposed contacts arranged in series along the other of the fenestration frame or the fenestration panel; wherein the plurality of bridge contacts project towards the plurality of opposed contacts; wherein the plurality of bridge contacts are configured to cooperatively deform.

Aspect 13 can include, or can optionally be combined with the subject matter of one or any combination of Aspects 1-12 to optionally include the interface assembly further includes: a sensor configured to detect the fenestration panel in one or more of the closed position or the open position.

Aspect 14 can include, or can optionally be combined with the subject matter of one or any combination of Aspects 1-13 to optionally include the fenestration panel includes one of a sash or a door panel.

Aspect 15 can include subject matter, such as an interface assembly coupled one of a fenestration panel or a fenestration frame, the interface assembly comprising: a housing coupled with one of the fenestration frame or the fenestration panel; one or more deformable bridge contacts retained within the housing, the one or more deformable bridge contacts include: a crest segment extending from a first crest end portion to a second crest end portion; and one or more opposed contacts coupled with the other of the fenestration panel or the fenestration frame; wherein the one or more deformable bridge contacts are configured to deform and engage the crest segment along the one or more opposed contacts.

Aspect 16 can include, or can optionally be combined with the subject matter of Aspect 15, to optionally include the housing is movably coupled with one of the fenestration frame or the fenestration panel.

Aspect 17 can include, or can optionally be combined with the subject matter of one or any combination of Aspects 15 or 16 to optionally include a housing biasing element configured to bias a carriage retaining the housing and the one or more deformable bridge contacts towards the one or more opposed contacts.

Aspect 18 can include, or can optionally be combined with the subject matter of one or any combination of Aspects 15-17 to optionally include a sensor coupled with the housing.

Aspect 19 can include, or can optionally be combined with the subject matter of one or any combination of Aspects 15-18 to optionally include the crest segment is cooperatively deformable with the one or more opposed contacts.

Aspect 20 can include, or can optionally be combined with the subject matter of one or any combination of Aspects 15-19 to optionally include the one or more deformable bridge contacts include: a trough segment coupled with crest and the trough segment is configured to provide a reciprocal mechanical bias to the crest segment.

Aspect 21 can include, or can optionally be combined with the subject matter of one or any combination of Aspects 15-20 to optionally include a carriage movably coupled with the fenestration panel, the carriage further includes: the housing retaining one or more wires in communication with the one or more deformable bridge contacts and the one or more opposed contacts.

Aspect 22 can include, or can optionally be combined with the subject matter of one or any combination of Aspects 15-21 to optionally include the interface assembly is a circuit configured to transmit one of power or data to at least one of the fenestration frame or the fenestration panel.

Aspect 23 can include, or can optionally be combined with the subject matter of one or any combination of Aspects 15-22 to optionally include the interface assembly is one of a plurality of interface assemblies arranged in series along one of the fenestration frame or the fenestration panel.

Aspect 24 can include, or can optionally be combined with the subject matter of one or any combination of Aspects 15-23 to optionally include each deformable bridge is configured to be in continuous engagement with the one or more opposed contacts of the plurality of interface assemblies.

Aspect 25 can include, or can optionally be combined with the subject matter of one or any combination of Aspects 15-24 to optionally include the one or more opposed contacts is at least one of a deformable bridge contact or an elongate contact.

Aspect 26 can include, or can optionally be combined with the subject matter of one or any combination of Aspects 15-25 to optionally include a keyway coupled with one of the fenestration panel or the fenestration frame; and a carriage floatably coupled within at least a portion of the keyway; wherein the carriage is coupled with a portion of the housing.

Aspect 27 can include subject matter, such as a method of providing continuous electrical communication between a fenestration frame and a fenestration panel, the method comprising: coupling one or more deformable bridge contacts to one of the fenestration frame or the fenestration panel; coupling one or more opposed contact to the other of the fenestration panel or the fenestration frame; and positioning the fenestration panel relative to the fenestration frame; wherein positioning the fenestration panel within the fenestration frame includes: engaging the one or more deformable bridge contacts against the opposed contact; deforming the one or more deformable bridge contacts against the opposed contact; and laterally distributing electrical contact along the one or more deformable bridge contacts and the opposed contact according to the deforming.

Aspect 28 can include, or can optionally be combined with the subject matter of Aspect 27, to optionally include providing a reciprocal bias distributed along the bridge contact from the one or more opposed contacts.

Aspect 29 can include, or can optionally be combined with the subject matter of one or any combination of Aspects 27 or 28 to optionally include laterally distributing electrical contact includes: providing a reciprocal bias distributed along the bridge contact according to the deforming of the one or more deformable bridge contacts.

Aspect 30 can include, or can optionally be combined with the subject matter of one or any combination of Aspects 27-29 to optionally include laterally distributing electrical contact includes: distributing a reciprocal bias along the one or more deformable bridge contacts.

Aspect 31 can include, or can optionally be combined with the subject matter of one or any combination of Aspects 27-30 to optionally include a plurality of bridge contacts includes the one or more deformable bridge contacts; wherein deforming the one or more deformable bridge contacts includes depressing one or more deformable bridge contacts of the plurality of bridge contacts with the one or more opposed contacts.

Aspect 32 can include, or can optionally be combined with the subject matter of one or any combination of Aspects 27-31 to optionally include providing a reciprocal bias along a transverse length of the one or more deformable bridge contacts relative to the opposed contact.

Aspect 33 can include, or can optionally be combined with the subject matter of one or any combination of Aspects 27-32 to optionally include depressing the one or more bridge contact includes: depressing the one or more deformable bridge contacts between at least a first end portion and a second end portion of the one or more deformable bridge contacts; and applying the reciprocal bias of at least a portion of the one or more deformable bridge contacts between the first end portion and the second end portions of the one or more deformable bridge contacts.

Aspect 34 can include, or can optionally be combined with the subject matter of one or any combination of Aspects 27-33 to optionally include moving the fenestration panel from a first position to a second position; wherein the first position is one of a closed or opened fenestration panel the second position is different; and moving the fenestration panel from the first position to the second position, includes; deforming one or more segments of the one or more deformable bridge contacts against the one or more opposed contacts; and maintaining continuous engagement between the one or more deformable bridge contacts with the one or more opposed contacts while moving the fenestration panel.

Aspect 35 can include, or can optionally be combined with the subject matter of one or any combination of Aspects 27-34 to optionally include the one or more opposed contacts is an opposing deformable bridge contact; wherein moving the fenestration panel includes: deforming at least one or more segments of the one or more opposed contacts in response to engagement with at least one of the one or more deformable bridge contacts.

Aspect 36 can include, or can optionally be combined with the subject matter of one or any combination of Aspects 27-35 to optionally include transmitting an electrical signal between one of the deformable bridge contacts and the opposed contact; wherein the electrical signal is one of power transmission or communication.

Aspect 37 can include, or can optionally be combined with the subject matter of one or any combination of Aspects 27-36 to optionally include the opposed contact is an elongate contact strip; wherein moving the fenestration panel includes: maintaining continuous engagement of the one or more deformable contacts along a length of the elongate contact strip.

Aspect 38 can include, or can optionally be combined with the subject matter of one or any combination of Aspects 27-37 to optionally include each of the one or more deformable bridge contacts includes a crest segment taper that tapers from a peak toward a crest end portion, and each one of the one or more opposed contacts includes an opposed taper that tapers from an opposed peak towards an opposed crest end portion, the method including: moving the fenestration panel from a first position to a second position; wherein the first position is one of a closed or opened fenestration panel the second position is different; wherein moving the fenestration panel from the first position to the second position, includes: contacting the crest segment taper of one or more deformable bridge contacts against the opposed taper of the one or more opposed contacts with the crest segment taper contacting an opposed crest surface of the one or more opposed contacts; and engaging the opposed taper against the crest segment taper of the one or more deformable bridge contacts.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A fenestration assembly comprising:
a fenestration frame;
a fenestration panel movably coupled with the fenestration frame, wherein the fenestration panel is configured to move between an open position and a closed positions; and
an interface assembly coupled between the fenestration frame and the fenestration panel, the interface assembly includes:
one or more bridge contacts coupled with one of the fenestration frame or fenestration panel, the one or more bridge contacts include:
a crest segment extending from a first crest end portion to a second crest end portion; and
one or more opposed contacts coupled with the other of the fenestration panel or the fenestration frame;
wherein the crest segment is deformably engaged with the one or more opposed contacts in each of the open and closed positions and intermediate positions therebetween.

2. The fenestration assembly of claim 1, wherein the one or more bridge contacts is a deformable, conductive interface.

3. The fenestration assembly of claim 1, wherein the crest segment deformably engaged with the one or more opposed contacts includes at least a portion of the crest segment is continuously deformably engaged.

4. The fenestration assembly of claim 1, wherein the one or more bridge contacts is a deformable and configured to provide a reciprocal bias distributed along each of the one or more bridge contacts toward the one or more opposed contacts.

5. The fenestration assembly of claim 1, wherein the crest segment is configured to be deformably engaged with the one or more opposed contacts includes deformable engagement and lateral distribution while the fenestration panel is in a moving configuration between the open and closed positions.

6. The fenestration assembly of claim 1, wherein the open position includes one or more of a fully open position and a partially open position;
wherein in the closed position included one or more of a fully closed position and a partially closed position.

7. The fenestration assembly of claim 1 wherein the one or more bridge contacts is configured to transmit at least one of data or power between the fenestration frame and the fenestration panel.

8. The fenestration assembly of claim 1 wherein the one or more bridge contacts include:
a trough segment coupled with crest and the trough segment is configured to provide a reciprocal mechanical bias.

9. The fenestration assembly of claim 1, wherein a reciprocal mechanical bias is opposed to deformation of the one or more bridge contacts.

10. The fenestration assembly of claim 1, wherein the one or more opposed contacts includes one or more opposed bridge contacts including:
an opposed crest segment; and
an opposed trough segment.

11. The fenestration assembly of claim 1, wherein the one or more opposed contacts includes an elongate strip contact, ribbon, or wire element.

12. The fenestration assembly of claim 1, including:
a plurality of bridge contacts arranged in series along one of the fenestration frame or the fenestration panel; and
a plurality of opposed contacts arranged in series along the other of the fenestration frame or the fenestration panel;
wherein the plurality of bridge contacts project towards the plurality of opposed contacts;
wherein the plurality of bridge contacts are configured to cooperatively deform.

13. The fenestration assembly of claim 1, wherein the interface assembly further includes:
a sensor configured to detect the fenestration panel in one or more of the closed position or the open position.

14. The fenestration assembly of claim 1, wherein the fenestration panel includes one of a sash or a door panel.

15. An interface assembly coupled one of a fenestration panel or a fenestration frame, the interface assembly comprising:
a housing coupled with one of the fenestration frame or the fenestration panel;
one or more deformable bridge contacts retained within the housing, the one or more deformable bridge contacts include:
a crest segment extending from a first crest end portion to a second crest end portion; and
one or more opposed contacts coupled with the other of the fenestration panel or the fenestration frame;
wherein the one or more deformable bridge contacts are configured to deform and engage the crest segment along the one or more opposed contacts.

16. The interface assembly of claim 15, wherein the housing is movably coupled with one of the fenestration frame or the fenestration panel.

17. The interface assembly of claim 15, including:
a housing biasing element configured to bias a carriage retaining the housing and the one or more deformable bridge contacts towards the one or more opposed contacts.

18. The interface assembly of claim 15, including:
a sensor coupled with the housing.

19. The interface assembly of claim 15, wherein the crest segment is cooperatively deformable with the one or more opposed contacts.

20. The interface assembly of claim 15, wherein the one or more deformable bridge contacts include: a trough segment coupled with crest and the trough segment is configured to provide a reciprocal mechanical bias to the crest segment.

21. The interface assembly of claim 15, including a carriage movably coupled with the fenestration panel, the carriage further includes:
the housing retaining one or more wires in communication with the one or more deformable bridge contacts and the one or more opposed contacts.

22. The interface assembly of claim 15, wherein the interface assembly is a circuit configured to transmit one of power or data to at least one of the fenestration frame or the fenestration panel.

23. The interface assembly of claim 15, wherein the interface assembly is one of a plurality of interface assemblies arranged in series along one of the fenestration frame or the fenestration panel.

24. The interface assembly of claim 23, wherein each deformable bridge is configured to be in continuous engagement with the one or more opposed contacts of the plurality of interface assemblies.

25. The interface assembly of claim 24, wherein the one or more opposed contacts is at least one of a deformable bridge contact or an elongate contact.

26. The interface assembly of claim 25, including:
a keyway coupled with one of the fenestration panel or the fenestration frame; and
a carriage floatably coupled within at least a portion of the keyway;
wherein the carriage is coupled with a portion of the housing.

27. A method of providing continuous electrical communication between a fenestration frame and a fenestration panel, the method comprising:
coupling one or more deformable bridge contacts to one of the fenestration frame or the fenestration panel;
coupling one or more opposed contact to the other of the fenestration panel or the fenestration frame; and
positioning the fenestration panel relative to the fenestration frame;
wherein positioning the fenestration panel within the fenestration frame includes:
engaging the one or more deformable bridge contacts against the opposed contact;
deforming the one or more deformable bridge contacts against the opposed contact; and
laterally distributing electrical contact along the one or more deformable bridge contacts and the opposed contact according to the deforming.

28. The method of providing the continuous electrical communication of claim 27, wherein laterally distributing electrical contact includes:
providing a reciprocal bias distributed along the bridge contact from the one or more opposed contacts.

29. The method of providing the continuous electrical communication of claim 27, wherein laterally distributing electrical contact includes:
providing a reciprocal bias distributed along the bridge contact according to the deforming of the one or more deformable bridge contacts.

30. The method of providing the continuous electrical communication of claim 27, wherein laterally distributing electrical contact includes:
distributing a reciprocal bias along the one or more deformable bridge contacts.

31. The method of providing the continuous electrical communication of claim 27, wherein a plurality of bridge contacts includes the one or more deformable bridge contacts;
wherein deforming the one or more deformable bridge contacts includes depressing one or more deformable bridge contacts of the plurality of bridge contacts with the one or more opposed contacts.

32. The method of providing the continuous electrical communication of claim 27, wherein engaging the one or more deformable bridge contacts includes:
providing a reciprocal bias along a transverse length of the one or more deformable bridge contacts relative to the opposed contact.

33. The method of providing the continuous electrical communication of claim 32, wherein depressing the one or more bridge contact includes:
depressing the one or more deformable bridge contacts between at least a first end portion and a second end portion of the one or more deformable bridge contacts; and
applying the reciprocal bias of at least a portion of the one or more deformable bridge contacts between the first end portion and the second end portions of the one or more deformable bridge contacts.

34. The method of providing the continuous electrical communication of claim 27, including:
moving the fenestration panel from a first position to a second position;
wherein the first position is one of a closed or opened fenestration panel the second position is different; and
moving the fenestration panel from the first position to the second position, includes;
deforming one or more segments of the one or more deformable bridge contacts against the one or more opposed contacts; and
maintaining continuous engagement between the one or more deformable bridge contacts with the one or more opposed contacts while moving the fenestration panel.

35. The method of providing the continuous electrical communication of claim 34, wherein the one or more opposed contacts is an opposing deformable bridge contact;
wherein moving the fenestration panel includes:
deforming at least one or more segments of the one or more opposed contacts in response to engagement with at least one of the one or more deformable bridge contacts.

36. The method of providing the continuous electrical communication of claim 27, further including:
transmitting an electrical signal between one of the deformable bridge contacts and the opposed contact;
wherein the electrical signal is one of power transmission or communication.

37. The method of providing the continuous electrical communication of claim 27, wherein the opposed contact is an elongate contact strip;
wherein moving the fenestration panel includes:
maintaining continuous engagement of the one or more deformable contacts along a length of the elongate contact strip.

38. The method of providing the continuous electrical communication of claim 27, wherein each of the one or more deformable bridge contacts includes a crest segment taper that tapers from a peak toward a crest end portion, and each one of the one or more opposed contacts includes an opposed taper that tapers from an opposed peak towards an opposed crest end portion, the method including:
moving the fenestration panel from a first position to a second position;
wherein the first position is one of a closed or opened fenestration panel the second position is different;
wherein moving the fenestration panel from the first position to the second position, includes:
contacting the crest segment taper of one or more deformable bridge contacts against the opposed taper of the one or more opposed contacts with the crest segment taper contacting an opposed crest surface of the one or more opposed contacts; and
engaging the opposed taper against the crest segment taper of the one or more deformable bridge contacts.
